(19) United States
(12) Patent Application Publication
(10) Pub. No.: US 2009/0001163 A1
(43) Pub. Date: Jan. 1, 2009

(54) Imaging scanner with illumination and exposure control

(75) Inventors: Edward D. Barkan, Miller Place, NY (US); James R. Giebel, Centerport, NY (US); Bradley S. Carlson, Huntington, NY (US); William Sackett, Rocky Point, NY (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: SYMBOL TECHNOLOGIES, INC., Holtsville, NY (US)

(21) Appl. No.: 11/823,220

(22) Filed: Jun. 27, 2007

(51) Int. Cl. G06K 7/10

(52) U.S. Cl. 235/454

(57) ABSTRACT

An imager (12) is provided for imaging target objects (26) comprising an illumination source (22) for providing illumination (24) that is reflected (30) from a target object (26), an intensity of the illumination being a function of a magnitude of current provided to the illumination source (22) and photosensitive circuitry (36) located within the imager (12) for capturing an image reflected from the target object (26) to the imager (12) while the imager is activated during an exposure period. The imager (12) further comprises a selectively adjustable imaging mode (120) for selecting either of: the magnitude of current (130) provided to the illumination source (22) or exposure period (230) of the imager such that the other of the magnitude of current or exposure period of the imager is automatically adjusted (150, 240) as a result of the selection.

### FIELD OF THE INVENTION

The present invention relates to a controlled imaging scanner and more specifically, an imaging scanner having controlled illumination and exposure modes for capturing target objects.

### BACKGROUND OF THE INVENTION

Various electro-optical systems have been developed for reading optical indicia, such as bar codes. A bar code is a coded pattern of graphical indicia comprised of a series of bars and spaces of varying widths, the bars and spaces having differing light reflecting characteristics. Some of the more popular bar code symbologies include: Uniform Product Code (UPC), typically used in retail stores sales; Code 39, primarily used in inventory tracking; and Postnet, which is used for encoding zip codes for U.S. mail. Systems that read and decode bar codes employing charged coupled device (CCD) or complementary metal oxide semiconductor (CMOS) based imaging systems are typically referred to hereinafter as imaging systems, imaging-based bar code readers, or imaging scanners.

Imaging systems electro-optically transform the graphic indicia into electrical signals, which are decoded into alphanumerical characters that are intended to be descriptive of the article or some characteristic thereof. The characters are then typically represented in digital form and utilized as an input to a data processing system for various end-user applications such as point-of-sale processing, inventory control and the like.

Imaging systems that include CCD, CMOS, or other imaging configurations comprise a plurality of photosensitive elements (photosensors) or pixels typically aligned in an array pattern that could include a number of arrays. The imaging-based bar code reader systems employ light emitting diodes (LEDs) or other light sources for illuminating a target object, e.g., a target bar code. Light reflected from the target bar code is focused through a lens of the imaging system onto the pixel array. As a result, the focusing lens generates an image from its field of view (FOV) that is projected onto the pixel array. Periodically, the pixels of the array are sequentially read out creating an analog signal representative of a captured image frame. The analog signal is amplified by a gain factor, by for example, an operational amplifier. The amplified analog signal is digitized by an analog-to-digital converter. Decoding circuitry of the imaging system processes the digitized signals representative of the captured image frame and attempts to decode the imaged bar code.

As mentioned above, imaging scanners typically employ an illumination system to flood a target object with illumination from a light source such as an LED in the reader. Light from the light source or LED is reflected from the target object. The reflected light is then focused through a lens of the imaging system onto the pixel array, the target object being within a field of view of the lens. It is not uncommon for a single imaging scanner to employ as an illumination source multiple LEDs or cluster of LEDs for producing illumination that is reflected from the target object. Such configurations undesirably demand a significant amount of power, reducing the battery life on portable or remote imaging scanners. A fixed amount of illumination is not always necessary based on environmental or imaging application changes. In order to conserve battery life or reduce power requirements, the following changes to conventional imaging scanner technology is proposed.

### SUMMARY OF THE INVENTION

The present invention relates to an imager for imaging target objects comprising an illumination source for providing illumination directed toward a target object, an intensity of the illumination being a function of a magnitude of current provided to the illumination source and photosensitive circuitry located within the imager for capturing an image from the target object while the imager is activated during an exposure period. The imager further comprises a selectively adjustable imaging mode for selecting either of: the magnitude of current provided to the illumination source or the exposure period of the imager such that the other of the magnitude of current or the exposure period is automatically adjusted as a result of the selection.

The present invention also relates to a method for imaging target objects comprising illuminating a target object with an illumination source to produce a reflected image of the target object, an intensity of the illumination being a function of a magnitude of current provided to the illumination source and capturing the reflected image of the target object on photosensitive circuitry located within the imager while the imager is activated during an exposure period. The method further comprises selecting an adjustable imaging mode for selecting either of: the magnitude of current provided to the illumination source or exposure period of the imager and automatically adjusting the other of the magnitude of current provided to the illumination source or exposure period of the imager as a result of the selection of the adjustable imaging mode.

The present invention further relates to an imager for imaging target objects comprising an illumination means for providing illumination that is reflected from the target object, an intensity of the illumination means being a function of a magnitude of current provided to the illumination means and capturing means located within the imager for capturing the image reflected from a target object to the imager while the imager is activated during an exposure period. The imager further comprises a selectively adjustable imaging mode for selecting either of: the magnitude of the current provided to the illumination source or exposure period of the imager such that the other of the magnitude of current or exposure period of the imager is automatically adjusted as a result of the selection.

The present invention yet further relates to an imaging-based reader for imaging target objects comprising an imager for imaging a target object. The imager is energized by a power source and an illumination source is provided for illumination that is directed toward the target object, an intensity of the illumination being a function of a magnitude of current provided to the illumination source. Photosensitive circuitry is located within the imager for capturing an image from the target object while the imager is activated during an exposure period. The imaging-based reader further comprises a selectively adjustable imaging mode for selecting either of: the magnitude of the current provided to the illumination source or the exposure period of the imager such that the other of the magnitude of current or exposure period of the imager is automatically adjusted as a result of the selection. A check routine is provided for determining the type of power source used to energize the imager. The adjustable imaging mode is disabled when the determined type of power source is an in-line power and the adjustable imaging mode is enabled when the determined type of power source is a remote power source.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a side elevation view of an imaging scanner constructed in accordance with one example embodiment of the present invention;

FIG. 2 is a schematic diagram illustrating a scan engine located within the imaging scanner of FIG. 1;

FIG. 3 is a block diagram illustrating an exemplary embodiment constructed in accordance with the present invention;

FIG. 4 is a block diagram illustrating another exemplary embodiment constructed in accordance with the present invention;

FIG. 5 is a block diagram illustrating another exemplary embodiment constructed in accordance with the present invention;

FIG. 6 is a block diagram illustrating another exemplary embodiment constructed in accordance with the present invention; and

FIG. 7 is a block diagram illustrating another exemplary embodiment constructed in accordance with the present invention.

### DETAILED DESCRIPTION

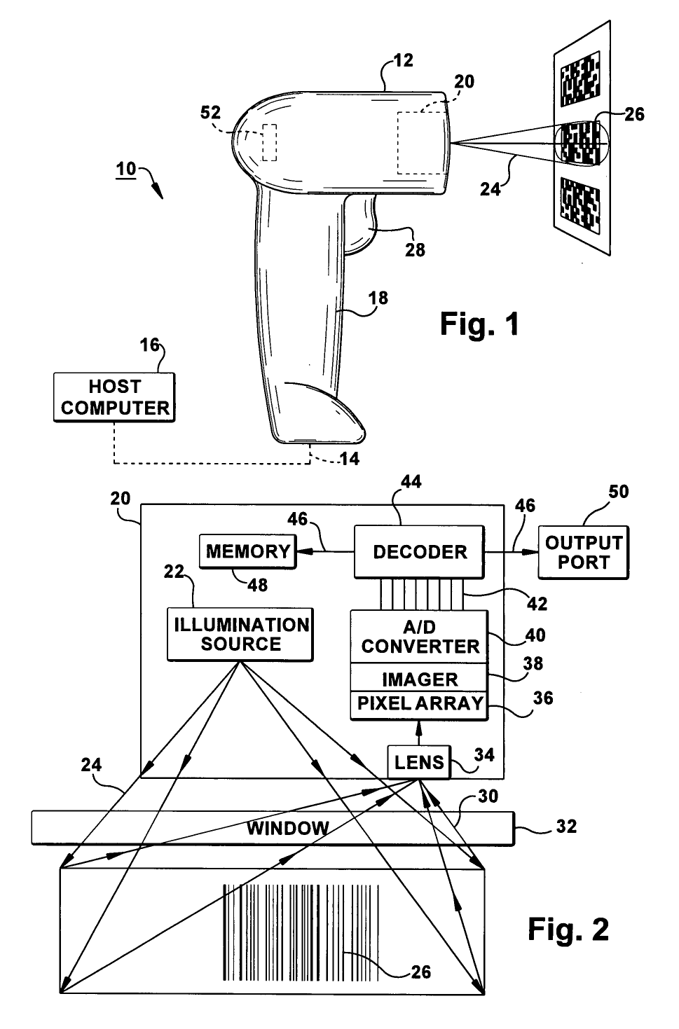

An imaging system 10 includes an imaging scanner 12 in communication 14 either through hard-wire or over-the-air (remote communication) to a host computer 16 as shown schematically in FIG. 1. The imaging scanner 12, in addition to imaging both 1D and 2D bar codes and postal codes, is also capable of capturing images and signatures. In one exemplary embodiment of the present invention, the imaging scanner 12 is a hand held portable imager supported in a housing 18 that can be carried and used by a user walking or riding through a store, warehouse, or plant for imaging bar codes for stocking and inventory control purposes.

However, it should be recognized that the imaging system 10 of the present invention, to be explained below, may be advantageously used in connection with any type of scanner or imaging device, be it portable or stationary. It is the intent of the present invention to encompass all such scanners and imagers.

Internal to the imaging scanner 12 is a scan engine 20. The scan engine 20 includes an illumination source 22 such as a light emitting diode (LED) or bank of LEDs for projecting light 24 at a target object 26 such as a bar code. The imaging scanner 12 can be automatically enabled, continuously enabled, or enabled by engaging a trigger 28, which initiates the projection of the light 24 in the hand-held system 10 as it is directed by a user toward the target object 26.

FIG. 2 is a schematic illustration of the scan engine 20 associated with the imaging scanner 12. Reflected light 30 from the target object 26 passes through a window 32 located in the housing 18 of the imaging scanner 12 onto a focusing lens 34 internal to the scan engine 20. The lens 34 focuses the reflected light onto a pixel array 36 of an imager element 38. The imager element 38 includes photosensitive elements such as the imaging pixel array 36 that could be for example, a charged coupled device (CCD) array or complementary metal oxide semiconductor (CMOS) array. The imager element 38 also includes an analog-to-digital (A/D) converter 40 for converting an analog signal produced by the imager element 38 over to the digital domain.

A bus connection 42 provides a communication link between the imager element 38 and a decoder 44. The bus connection 42 is a high-speed (8) bit parallel interface for providing a digital signal to the decoder 44 representative of the captured image frame. The decoder 44 processes the digitized signals and attempts to decode the target object 26 into decoded information 46. The decoded information 46 can be stored locally by the scan engine 20 in memory 48 and/or communicated to a peripheral device (not shown) such as a monitor or remote computer through an output port 50.

The amount of power consumed by imaging scanner is an important issue, especially for portable scanners powered by their own remote (non-lined) power supply, such as a battery. The more power used during the scanning operation the greater the operating costs, and for portable scanners, the greater the power consumption, the greater the reduction in power or battery life. One of the largest sources of power and operating costs in the imaging scanners is the illumination source, which can include a single or multiple LEDs for capturing images of the target objects. Conventional imaging scanners typically provide a fixed amount of illumination, independent of the application or surrounding conditions.

In an exemplary embodiment, the imaging system 10 of FIG. 1 advantageously provides an imaging scanner with selectable exposure control that regulates that amount of illumination being used based on, for example, the imager's application, use, or environment. The selectable exposure control is programmable such that the scan engine 20 or imaging scanner 12 can be optimized for a particular product (for example stationary or portable scanners) and for the application in which the imaging scanner 12 is used. For example, applications where the barcode or scanner is in motion may require a shorter exposure time and will likely use the brightest available illumination. Alternatively, other applications where overall power consumption or maximum peak current is most critical, the illumination can be selectively controlled to a lower illumination setting and the exposure is controlled to allow for longer exposure times.

In the illustrated exemplary embodiment of FIG. 1, the imaging scanner 12 includes a selectable control 52 that could represent a dial, dual in-line package (DIP) type switch or any other type of switch that would allow for a manual adjustment to selectively control the amount of illumination or exposure time of the imaging scanner 12. In an alternative exemplary embodiment, the illumination or exposure time is adjusted automatically by electronics or programming located in the imaging scanner 12 and/or the host computer 16.

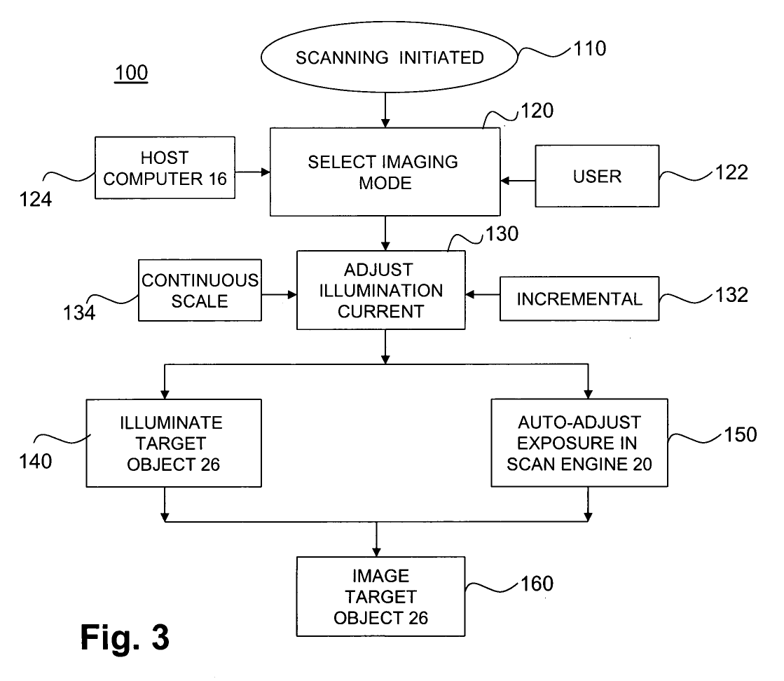

FIG. 3 illustrates one exemplary embodiment of an imaging scanning process 100 of the imaging system 10 in which the amount of current provided to the illumination source 22 is selectively controlled. The imaging or scanning process is initiated at 110 by for example, engaging the trigger 28, or providing power to the imaging scanner 12 through a remote power supply located within the imaging scanner 12, or from a signal or power provided from the host computer 16. The imaging mode 120 is selected either manually by a user at 122 or automatically by the host computer 16 at 124. The manual selection of the imaging mode 120 is achieved, for example, by the selectable control 52 located on the imaging scanner 12 or equivalent type switch located on the host computer 16.

The imaging mode 120 controls in the scan engine 20 the amount of illumination provided by the illumination source 22 by controlling the amount of current used at 130. The adjustment of the illumination current 130 can be incremental, having two or more incremental values or settings at 132, or alternatively, could be any value selected on a continuous scale at 134.

Once the adjustment to the illumination current is made at 130, the illumination source 22 illuminates the target object 26 at 140. Substantially simultaneously, the exposure time of the scan engine 20 is automatically adjusted at 150 to compensate for the selected illumination current at 130. The automatic adjustment of scan engine 20 exposure time at 150 is achieved, for example, by a look-up table programmed into the scan engine 20, host computer 16, or related circuitry, in which the amount of exposure time is set for the amount of current provided to the illumination source 22. The automatic exposure time adjustment changes the total amount of light that the scan engine 20 allows on the photosensitive sensor, such as the pixel, CMOS, or CCD array 36. If the current selection 130 is relatively low, then the exposure time is longer, providing more light to the array 36. Alternatively, if the current selection is relatively high, then the exposure time is shorter, providing less light to the array 36.

The imaging mode 120 controlling the scan engine 20 is achieved through the electronics in the scan engine, an application specific integrated circuit (ASIC) coupled to the scan engine, computer readable programming read by the scan engine, or any combination thereof. Once the target object 26 is illuminated and the exposure time of the scan engine 20 is adjusted, the target object is imaged by the scan engine at 160.

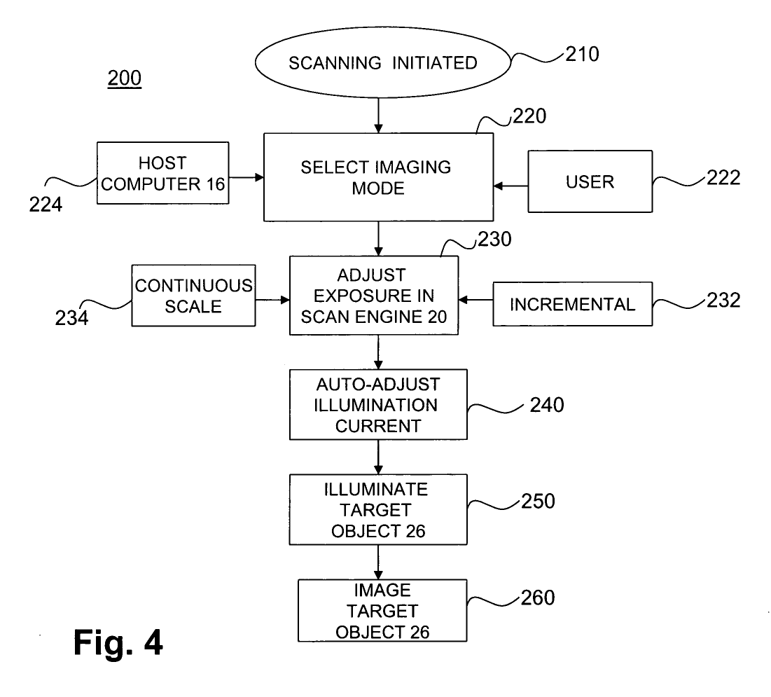

FIG. 4 illustrates one exemplary embodiment of an imaging scanning process 200 of the imaging system 10 in which the amount of exposure time in the imaging scanner 12 is selectively controlled. The imaging or scanning process is initiated at 210 by for example, engaging the trigger 28, or providing power to the imaging scanner 12 through a remote power supply located within the imaging scanner 12, or from a signal or power provided from the host computer 16. The imaging mode 220 is selected either manually by a user at 222 or automatically by the host computer 16 at 224. The manual selection of the imaging mode 220 is achieved, for example, by the selectable control 52 located on the imaging scanner 12 or equivalent type switch located on the host computer 16.

The imaging mode 220 controls in the scan engine 20 the amount of exposure time provided by the scan engine 20 to the pixel array 36 at 230. The exposure time adjustment 230 can be incremental, having two or more incremental values or settings at 232, or alternatively, could be any value selected on a continuous scale at 234.

Once the adjustment to the exposure time is made at 230, an automatic adjustment is made to the amount of current that is provided to the illumination source 22 at 240. The automatic adjustment of the current at 240 provided to the illumination source 22 is achieved, for example, by a look-up table programmed into the scan engine 20, host computer 16, or related circuitry, in which the amount of current is set for the amount of exposure selectively controlled at 230. Selection of the imaging mode 220 adjusts the amount of light and duration that the scan engine 20 allows on the photosensitive sensor, such as the pixel, CMOS, or CCD array 36. If the selected exposure is relatively slow, then the exposure time is longer, requiring less current to the illumination source 22 in order to provide the necessary illumination to the array 36. Alternatively, if the exposure is relatively fast, then the exposure time is shorter, requiring more current to the illumination source 22 in order to provide the necessary illumination to the array 36.

The imaging mode 220 controlling the scan engine 20 is achieved through the electronics in the scan engine, an (ASIC) coupled to the scan engine, computer readable programming read by the scan engine, or any combination thereof. Once the auto-adjustment to the illumination current 240 occurs, the target object 26 is illuminated at 250 and imaging of the target object 26 commences by the scan engine 20 at 260.

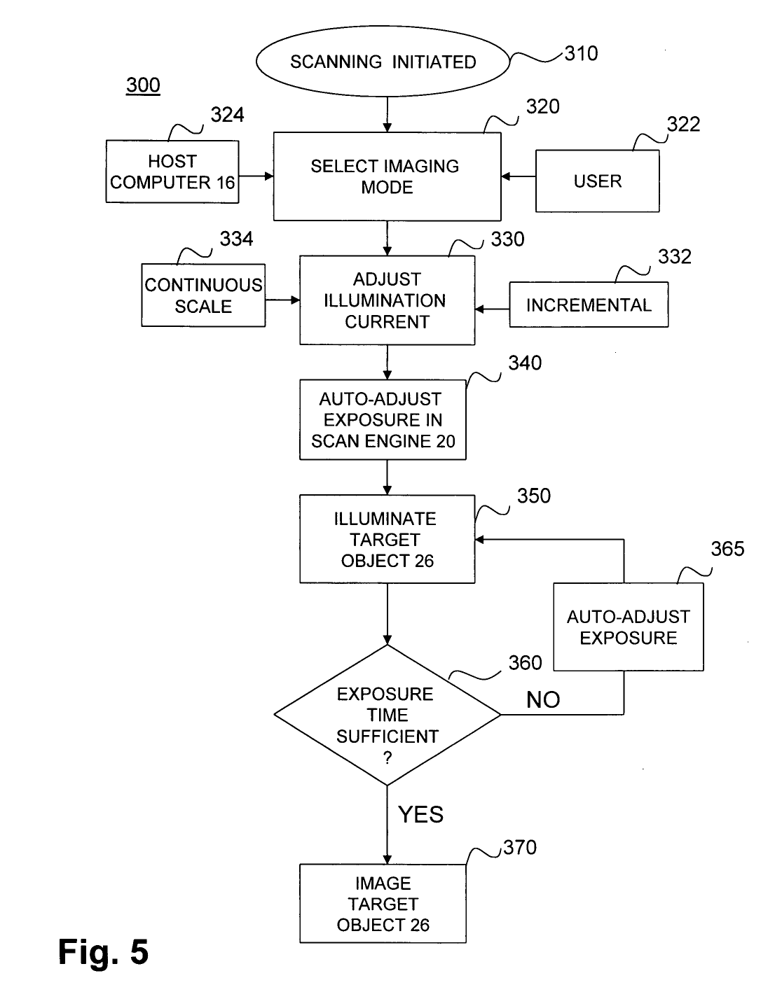

FIG. 5 illustrates one exemplary embodiment of an imaging scanning process 300 of the imaging system 10 in which the amount of current provided to the illumination source 22 in the imaging scanner 12 is selectively controlled and the exposure time is auto-adjusted by heuristic techniques. The imaging or scanning process is initiated at 310 by for example, engaging the trigger 28, or providing power to the imaging scanner 12 through a remote power supply located within the imaging scanner 12, or from a signal or power provided from the host computer 16. The imaging mode 320 is selected either manually by a user at 322 or automatically by the host computer 16 at 324. The manual selection of the imaging mode 320 is achieved, for example by the selectable control 52 located on the imaging scanner 12 or equivalent type switch located on the host computer 16.

The imaging mode 320 controls in the scan engine 20 the amount of illumination provided by the illumination source 22 by controlling the amount of current used at 330. The adjustment of the illumination current 330 can be incremental, having two or more incremental values or settings at 332, or alternatively, could be any value selected on a continuous scale at 334.

Once the adjustment to the illumination current is made at 330, the exposure time of the scan engine 20 is automatically adjusted at 340 to compensate for the selected illumination current at 330. Illumination is then provided to the target object 26 at 350. A determination is then made at 360 as to whether the amount of exposure time was sufficient, by for example, algorithms or heuristic techniques programmed within the scan engine 20 or host computer 16. If the determination at 360 finds that the amount of illumination is insufficient, the exposure time is adjusted appropriately at 365, by for example, an incremental increase in the exposure time. An attempt to illuminate the target object 26 is again made at 350. If the determination at 360 is in the affirmative, the target object 26 is imaged at 370.

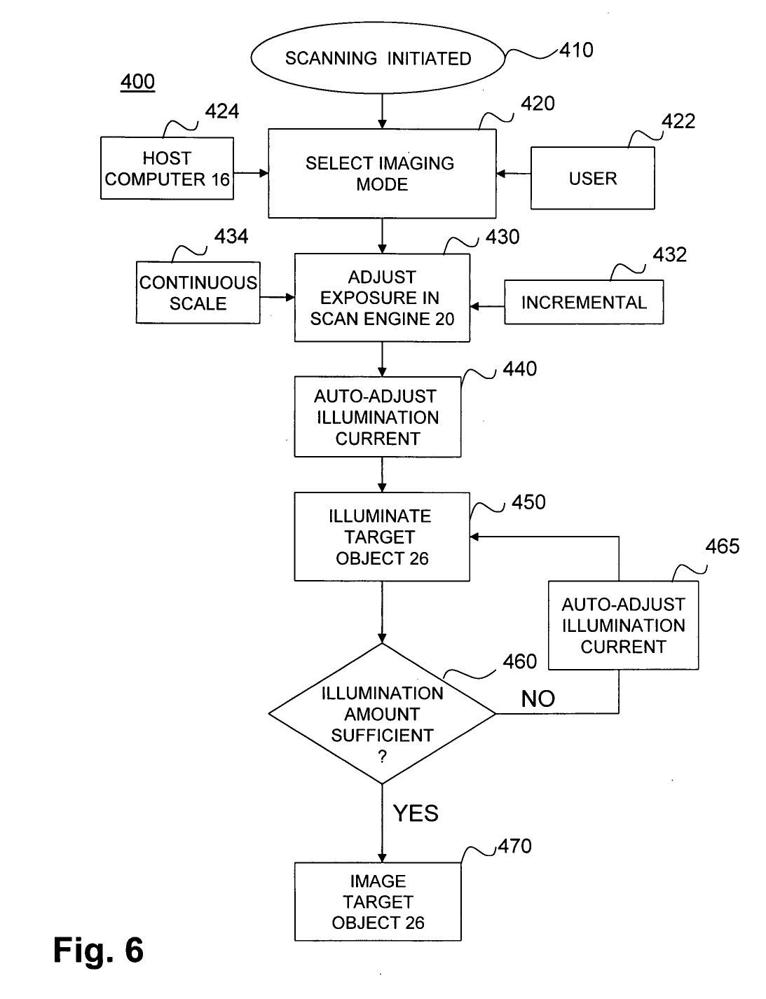

FIG. 6 illustrates one exemplary embodiment of an imaging scanning process 400 of the imaging system 10 in which the amount of exposure time in the imaging scanner 12 is selectively controlled and the amount of illumination current provided to the illumination source 22 is auto-adjusted by heuristic techniques. The imaging or scanning process is initiated at 410 by for example, engaging the trigger 28, or providing power to the imaging scanner 12 through a remote power supply located within the imaging scanner 12, or from a signal or power provided from the host computer 16. The imaging mode 420 is selected either manually by a user at 422 or automatically by the host computer 16 at 424. The manual selection of the imaging mode 420 is achieved, for example by the selectable control 52 located on the imaging scanner 12 or equivalent type switch located on the host computer 16.

The imaging mode 420 controls in the scan engine 20 the amount of exposure time provided by the scan engine 20 to the pixel array 36 at 430. The exposure time adjustment 430 can be incremental, having two or more incremental values or settings at 432, or alternatively, could be any value selected on a continuous scale at 434.

Once the adjustment to the exposure time is made at 430, an automatic adjustment is made to the amount of current that is provided to the illumination source 22 at 440. Illumination is then provided to the target object 26 at 450. A determination is then made at 460 as to whether the amount of illumination provided at 450 was sufficient, by for example, algorithms or heuristic techniques programmed within the scan engine 20 or host computer 16. If the determination at 460 finds that the amount of illumination is insufficient, the amount of current is adjusted appropriately at 465, by for example, an incremental increase to the current supplied to the illumination source 22. An attempt to illuminate the target object 26 is again made at 450. If the determination at 460 is in the affirmative, the target object 26 is imaged at 470.

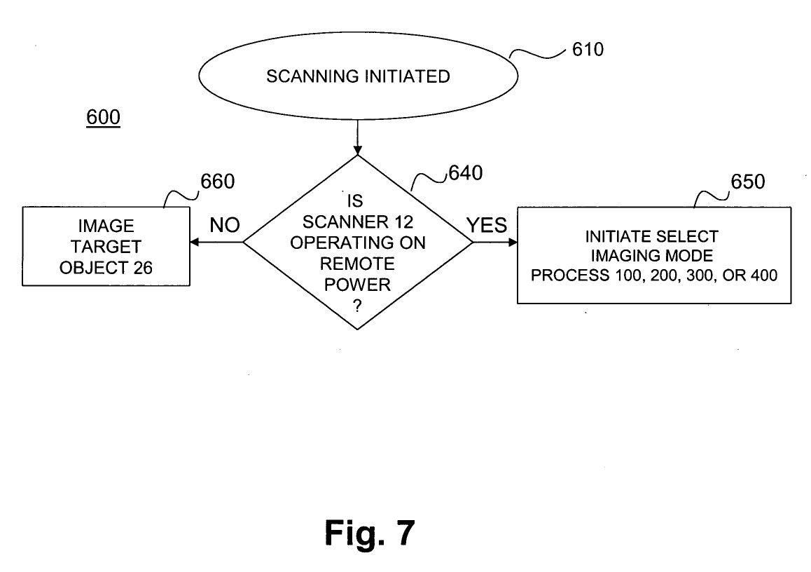

FIG. 7 illustrates another exemplary embodiment of an imaging scanning process 600 in which the process applied to the imaging scanner 12 is a function of the source of power supplied to the imaging scanner 12. The process is initiated at 610 by for example, engaging the trigger 28, or providing power to the imaging scanner 12 through a remote power supply located within the imaging scanner 12, or from a signal or power provided from the host computer 16. Throughout the imaging process 600 a check 640 is made as to the source of power provided to the imaging scanner 12. If the imaging scanner is operating from in-line power (either alternating current or direct current), the target object 26 is imaged at 660 without altering the amount of current provided to the illumination source 22. If the check at 640 determines that the imaging scanner has a change in its power source (such as changing from in-line to battery power), or is on remote (battery) power, conservation techniques such as the processes 100, 200, 300, or 400 are implemented to conserve the remote power.

While the present invention has been described with a degree of particularity, it is the intent that the invention includes all modifications and alterations from the disclosed design falling within the spirit or scope of the appended claims.

Having described the invention, the following is claimed:

1. An imager for imaging target objects comprising:
an illumination source for providing illumination directed toward a target object, an intensity of the illumination being a function of a magnitude of current provided to the illumination source;
photosensitive circuitry located within said imager for capturing an image from the target object while the imager is activated during an exposure period; and
a selectively adjustable imaging mode for selecting either of: the magnitude of current provided to said illumination source or the exposure period of said imager such that the other of said magnitude of current or the exposure period is automatically adjusted as a result of said selection.

2. The imager of claim 1 wherein said automatic adjustment is achieved by heuristic techniques.

3. The imager of claim 1 wherein said automatic adjustment is achieved by look-up table.

4. The imager of claim 1 wherein said imager is a scan engine.

5. The imager of claim 1 wherein said imager is a hand-held imaging scanner.

6. The imager of claim 1 wherein said imager is a stationary imaging scanner.

7. The imager of claim 1 wherein said imager is a portable imaging scanner controlled by a remote power source localized to said portable imaging scanner.

8. The imager of claim 1 wherein said selectively adjustable imaging mode is automatically selected.

9. The imager of claim 1 wherein said selectively adjustable imaging mode is manually selected.

10. The imager of claim 1 wherein said automatic adjustment to said illumination current or exposure period is incrementally adjusted.

11. The imager of claim 1 wherein said automatic adjustment to said illumination current or exposure period is on a continuous scale.

12. The imager of claim 1 wherein said imager further comprises a check routine for determining the source or type of power provided to said imager.

13. The imager of claim 12 wherein said imager enables and disables said selectively adjustable imaging mode depending on the findings of said check routine.

14. The imager of claim 13 wherein said check routine determines the type of power source used to energize said imager, the adjustable imaging mode being disabled when the determined type of power source used is an in-line power and the adjustable imaging mode is enabled when the determined type of power source is a remote power source.

15. A method for imaging target objects comprising:
illuminating a target object with an illumination source to produce a reflected image of the target object, an intensity of the illumination being a function of a magnitude of current provided to the illumination source;
capturing the reflected image of the target object on photosensitive circuitry located within said imager while the imager is activated during an exposure period;
selecting an adjustable imaging mode for selecting either of: the magnitude of current provided to the illumination source or exposure period of said imager; and
automatically adjusting the other of said magnitude of current provided to the illumination source or exposure period of said imager as a result of said selection of said adjustable imaging mode.

16. The method of imaging of claim 15 wherein said automatically adjusting the other of said magnitude of current to the illumination source or exposure period of said imager is achieved by heuristic techniques.

17. The method of imaging of claim 15 wherein said automatically adjusting the other of said magnitude of current to the illumination source or exposure period of said imager is achieved by a look-up table.

18. The method of imaging of claim 15 further comprising checking the source or type of power provided to said imager by a check routine and enabling or disabling said adjustable imaging based on the results of said check routine.

19. The method of claim 18 further comprising disabling the adjustable imaging mode when said check routine determines the type of power is in-line power and enabling the adjustable imaging mode when said check routine determines the type of power is remote power.

20. An imager for imaging target objects comprising:
an illumination means for providing illumination that is reflected from the target object, an intensity of the illumination means being a function of a magnitude of current provided to the illumination means;
capturing means located within said imager for capturing the image reflected from a target object to the imager while the imager is activated during an exposure period; and
a selectively adjustable imaging mode for selecting either of: the magnitude of the current provided to said illumination source or exposure period of said imager such that the other of said magnitude of current or exposure period of said imager is automatically adjusted as a result of said selection.

21. An imaging-based reader for imaging target objects comprising:
an imager for imaging a target object, the imager energized by a power source;
an illumination source for providing illumination directed toward the target object; an intensity of the illumination being a function of a magnitude of current provided to the illumination source;
photosensitive circuitry located within said imager for capturing an image from the target object while the imager is activated during an exposure period;
a selectively adjustable imaging mode for selecting either of: the magnitude of the current provided to the illumination source or the exposure period of said imager such that the other of the magnitude of current or exposure period of said imager is automatically adjusted as a result of said selection; and
a check routine for determining the type of power source used to energize the imager, the adjustable imaging mode disabled when the determined type of power source is an in-line power and said adjustable imaging mode enabled when the determined type of power source is a remote power source.

22. The imaging-based reader of claim 21 wherein said automatic adjustment is achieved by heuristic techniques.

23. The imaging-based reader of claim 21 wherein said automatic adjustment is achieved by a look-up table.

24. The imaging-based reader of claim 21 wherein said selectively adjustable imaging mode is automatically selected.

25. The imaging-based reader of claim 21 wherein said selectively adjustable imaging mode is manually selected.
